(19) United States
(12) Patent Application Publication
(10) Pub. No.: US 2006/0278632 A1
(43) Pub. Date: Dec. 14, 2006

(54) Junction box for ceiling fan support

(76) Inventor: Jen-Lung David Tai, Glendale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/151,901

(22) Filed: Jun. 14, 2005

(51) Int. Cl. H02G 3/08

(52) U.S. Cl. 220/3.2

(57) ABSTRACT

A junction box includes an annularly configured sidewall bounding an internally open cavity extending between a top end of the sidewall and a bottom end of the sidewall, and a top wall overlying the top end of the sidewall. A tower bracket has opposing upstanding struts affixed to the top wall and projects downwardly therefrom in the open cavity terminating with lower extremities affixed to an attachment tab positioned at the bottom end of the sidewall.

### FIELD OF THE INVENTION

The present invention relates to junction boxes and, more particularly, to junction boxes for supporting ceiling fans.

### BACKGROUND OF THE INVENTION

Ceiling fans typically have a dynamic load of about 25 to 100 pounds. A common form of support often utilized to support a ceiling fan a modified electrical junction box having load supporting features making it capable of handling increased load. The box can be secured to the underside of a joist or other available mounting surface at the installation site, or to an inter-joist hanger. The use of an electrical junction box is essential for installation of a ceiling fan to accommodate the electrical connections required for the ceiling fan.

Other load-bearing junction boxes include support bolts that depend from the top wall of the junction box to below the lower end of the box to a distal threaded end onto which the load is received and secured. This arrangement enables the top wall, rather than the conventional junction box tabs, to sustain the load, and is widely used.

In many installations, however, the use of a downwardly depending bolt is difficult if not impossible to employ. In some instances, the support bolts are relatively inverted being installed upward from beneath the junction box to engage a threaded opening formed in the upper wall. The upper wall of the box in this arrangement functions as the fastener nut for the support bolt. While relatively simple and convenient, the loading capability of this arrangement is limited by the afforded threaded length of the threaded opening through the upper wall. Although skilled artisans have attempted to devise solutions to these and other problems prevalent in the art, current efforts continue to be not entirely satisfactory as it has been discovered that they are difficult to construct, difficult to use and install, and expensive.

### SUMMARY OF THE INVENTION

According to the invention, a junction box includes an annularly configured sidewall bounding an internally open cavity extending between a top end of the sidewall and a bottom end of the sidewall. A top wall overlies the top end of the sidewall. A tower bracket includes opposing upstanding struts affixed to the top wall, and that project downwardly therefrom in the open cavity terminating with lower extremities affixed to an attachment tab positioned at the bottom end of the sidewall. In a particular embodiment, the attachment tab is fashioned with a threaded opening, and in another embodiment the attachment tab is fashioned with a plurality of threaded openings. The struts have upper ends, and mounting tabs, each carried by one of the upper ends of the struts, are affixed to the top wall. In an exemplary embodiment, there is an opening through the attachment tab, and an attachment clip is coupled to the attachment tab. The attachment clip has opposing clip extremities positioned on either side of the opening through the attachment tab, and there are opposing threaded openings through the clip extremities, respectively. Preferably, the opposing upstanding struts are substantially parallel relative to each other. In a particular embodiment, the top wall has an outer surface and an opposing inner surface directed toward the open cavity, and there is an opening through the top wall. The upper ends of the struts extend through the opening through the top wall, and the mounting tabs are removably affixed to the outer surface of the top wall, such as with threaded screws or the like.

According to the invention, a junction box includes an annularly configured sidewall bounding an internally open cavity extending between a top end of the sidewall and a bottom end of the sidewall. A top wall overlies the top end of the sidewall, and there is a tower bracket including opposing, substantially parallel struts positioned in the open cavity and having upper extremities, each having a mounting tab removably affixed to the top wall, and opposing lower extremities affixed to an attachment tab positioned at the bottom end of the sidewall. In one embodiment there is a threaded opening through the attachment tab, and in another embodiment there is a plurality of threaded openings through the attachment tab. In a particular embodiment, there is an opening through the attachment tab, and an attachment clip is coupled to the attachment tab. The attachment clip has opposing clip extremities positioned on either side of the opening, and there are opposing threaded openings through the clip extremities, respectively. Preferably, the top wall has an outer surface and an opposing inner surface directed toward the open cavity. An opening extends through the top wall, the upper extremities of the tower bracket extend through the opening through the top wall, and the mounting tabs are removably affixed to the outer surface of the top wall, such as with screws or the like.

According to the invention, a junction box includes an annularly configured sidewall bounding an internally open cavity extending between a top end of the sidewall and a bottom end of the sidewall. A top wall overlies the top end of the sidewall. Further included is a tower bracket, which includes opposing upstanding struts positioned in the open cavity and including upper extremities, each having a mounting tab, and opposing lower extremities affixed to an attachment tab positioned at the bottom end of the sidewall. The top wall has an outer surface and an opposing inner surface directed toward the open cavity. An opening extends through the top wall, the upper extremities of the tower bracket extend through the opening through the top wall, and the mounting tabs are removably affixed to the outer surface of the top wall, such as with screws or the like. In a particular embodiment, a threaded opening extends through the attachment tab, and in another embodiment a plurality of threaded openings extend through the attachment tab. In another embodiment, an opening extends through the attachment tab, and an attachment clip is coupled to the attachment tab. The attachment clip has opposing clip extremities positioned on either side of the opening, and opposing threaded openings extend through the clip extremities, respectively. Preferably, the opposing upstanding struts are substantially parallel relative to each other.

Consistent with the foregoing summary of preferred embodiments, and the ensuing detailed description, which are to be taken together, the invention further contemplates associated apparatus and method embodiments.

### BRIEF DESCRIPTION OF THE DRAWINGS

Referring to the drawings:

FIG. 1 is a perspective view of a ceiling fan supported by a junction box attached to an inter-joist hanger, the junction box constructed and arranged in accordance with the principle of the invention;

FIG. 2 is an exploded perspective view of the junction box of FIG. 1;

FIG. 3 is an enlarged, fragmented, partially exploded perspective view of the junction box of FIG. 1;

FIG. 4 is a side elevational view of the junction box of FIG. 1 with portions thereof shown in vertical cross section for illustrative purposes;

FIG. 5 is a top plan view of the junction box of FIG. 1;

FIG. 6 is a top plan view of an alternate embodiment of a junction box constructed and arranged in accordance with the principle of the invention;

FIG. 7 is a side elevational view of the junction box of FIG. 6 with portions thereof shown in vertical cross section for illustrative purposes;

FIG. 8 is an exploded perspective view of a tower bracket with attachment clip for use with a junction box in accordance with the principle of the invention;

FIGS. 9A-C represent different threaded hole patterns for use in conjunction with the attachment clip of the tower bracket of FIG. 8;

FIG. 10 is a fragmented perspective view of a junction box incorporating a keyholed knockout plug constructed and arranged in accordance with the principle of the invention;

FIG. 11 is an enlarged perspective view of the keyholed knockout plug of FIG. 10;

FIG. 12 is an enlarged perspective view of the keyholed knockout plug of FIG. 10 showing a screwdriver positioned at a keyhole of the keyholed knockout plug;

FIG. 13 is a perspective view of another embodiment of a junction box incorporating keyholed knockout plugs constructed and arranged in accordance with the principle of the invention;

FIG. 14 is a vertical sectional view of a mounting assembly for use with a junction box, the mounting assembly constructed and arranged in accordance with the principle of the invention;

FIG. 15 is a vertical sectional view of another embodiment of a mounting assembly for use with the junction box of FIG. 14, the mounting assembly constructed and arranged in accordance with the principle of the invention;

FIG. 16 is a vertical sectional view of a shoulder rivet for use with a junction box, the shoulder rivet constructed and arranged in accordance with the principle of the invention;

FIG. 17 is a perspective view of a junction box constructed and arranged in accordance with the principle of the invention, in which FIGS. 14 and 15 show a sectional portion thereof;

FIG. 18 is a bottom plan view of the junction box of FIG. 17;

FIGS. 19 and 20 are fragmented vertical sectional views of another embodiment of a junction box showing a mounting assembly incorporated therewith constructed and arranged in accordance with the principle of the invention;

FIG. 21 is bottom perspective view of bumper used in junction with the mounting assembly depicted in FIGS. 19 and 20;

FIG. 22 is a top perspective view of the bumper of FIG. 21; and

FIG. 23 is a bottom plan view of yet another embodiment of a junction box constructed and arranged in accordance with the principle of the invention.

### DETAILED DESCRIPTION OF PREFERRED EMBODIMENTS

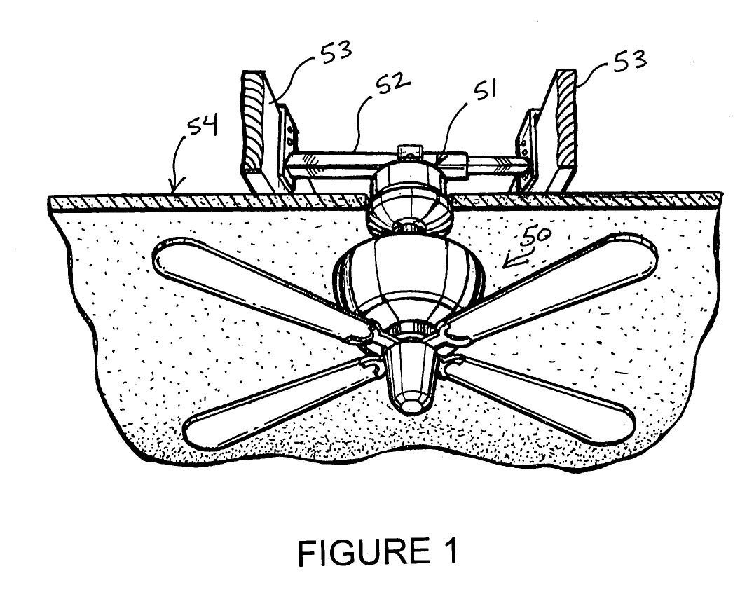

Turning now to the drawings, in which like reference characters indicate corresponding elements throughout the several views, attention is first directed to FIG. 1 in which there is seen a perspective view of a ceiling fan 50 supported by a junction box 51 attached to an inter-joist hanger 52 secured to opposing joists 53 of a ceiling structure 54, junction box 51 being constructed and arranged in accordance with the principle of the invention. Junction box 51 is suspended from inter-joist hanger 52 in FIG. 1 as a matter of example, and it is to be understood that junction box 51 may be fastened to a ceiling structure in other ways, such as to the underside of a joist or other available mounting surface.

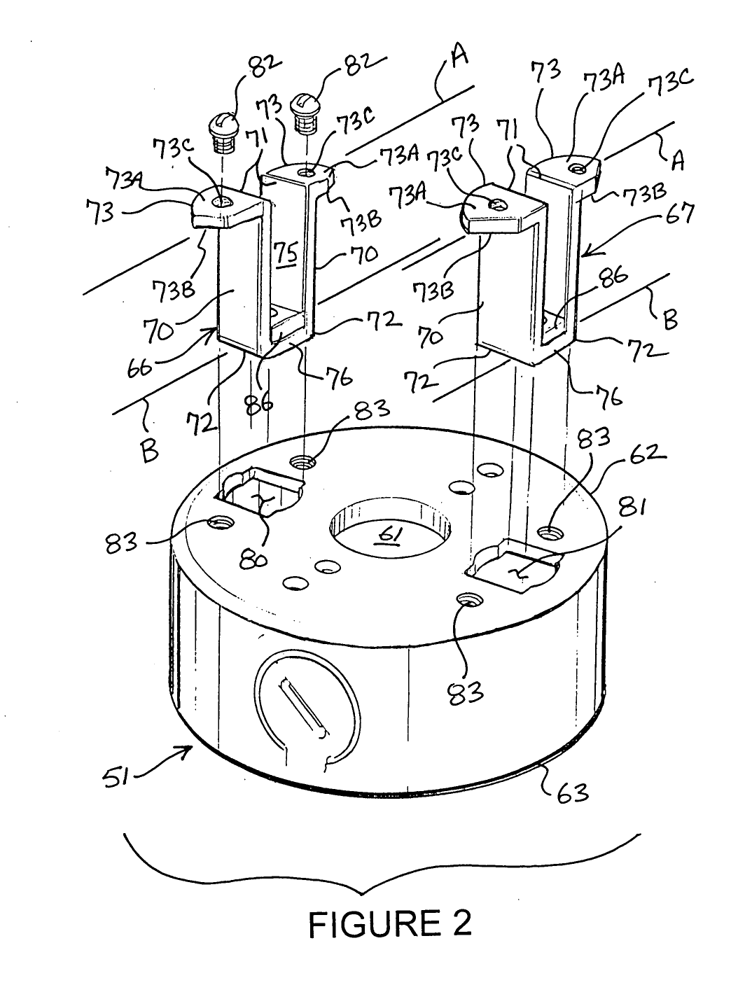

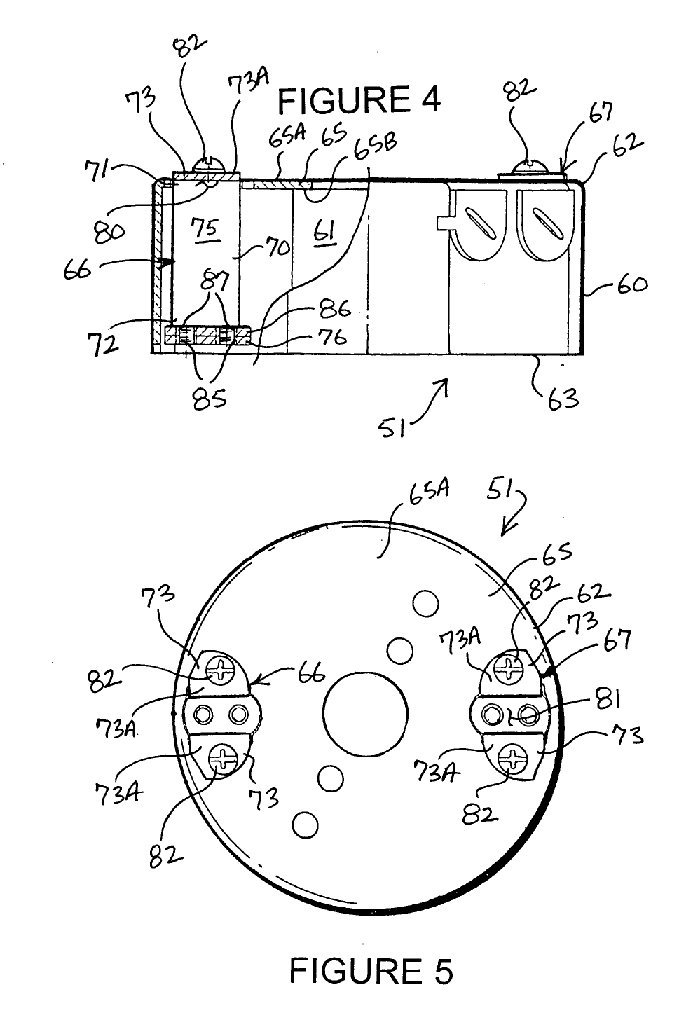

Looking to FIGS. 2 and 4, box 51, which is a standard-sized junction box, includes an annular sidewall 60 bounding an internally open cavity 61 extending between a top end 62 of sidewall 60 and a bottom end 63 of sidewall 60. Bottom end 63 represents the underside of box 51. A top wall 65 overlies top end 62 of sidewall 60 and is integrally joined to top end 62. As best seen in FIG. 5, top wall 65 has an upper/outer surface 65A and an opposing lower/inner surface 65B facing cavity 61. Sidewall 60 and top wall 65 are fashioned integrally of steel, aluminum, titanium, or the like, being strong and highly resilient.

As seen in FIG. 2, box 51 incorporates tower brackets 66 and 67 constructed and arranged in accordance with the principle of the invention. Tower brackets 66 and 67 are identical to one another and the structure of only one will now be discussed with the understanding that the ensuing discussion applies to each tower bracket incorporated with box 51.

Tower bracket 66 is integrally formed from steel, aluminum, titanium or the like, and consists of opposing, coextensive, spaced-apart, parallel struts 70 each having an upper end/extremity 71 and an opposing lower end/extremity 72. A mounting tab 73 is attached to each upper end 71. Mounting tabs 73 are diametrically opposed, reside in a common horizontal plane A and are formed laterally outward away from one another, and each having an upper surface 73A and an opposing lower surface 73B, in accordance with the principle of the invention. Struts 70 form a gap 75 therebetween from upper ends 71 to lower ends 72. Lower ends 72 are affixed to an attachment tab 76 to which a load is to be engaged and which spans gap 75 at lower ends 72 and which resides in a horizontal plane B which is spaced from and parallel to horizontal plane A. For the purpose of orientation and reference, it is to be understood that the upper ends 71 of struts 70 represent the upper end of tower bracket 66, and that lower ends 72 of struts 70 represent the lower end of tower bracket 66. As previously indicated, tower brackets 66 and 67 are identical to one another, and in FIG. 2 the same reference characters used in conjunction with tower bracket 66 are denoted in conjunction with tower bracket 67.

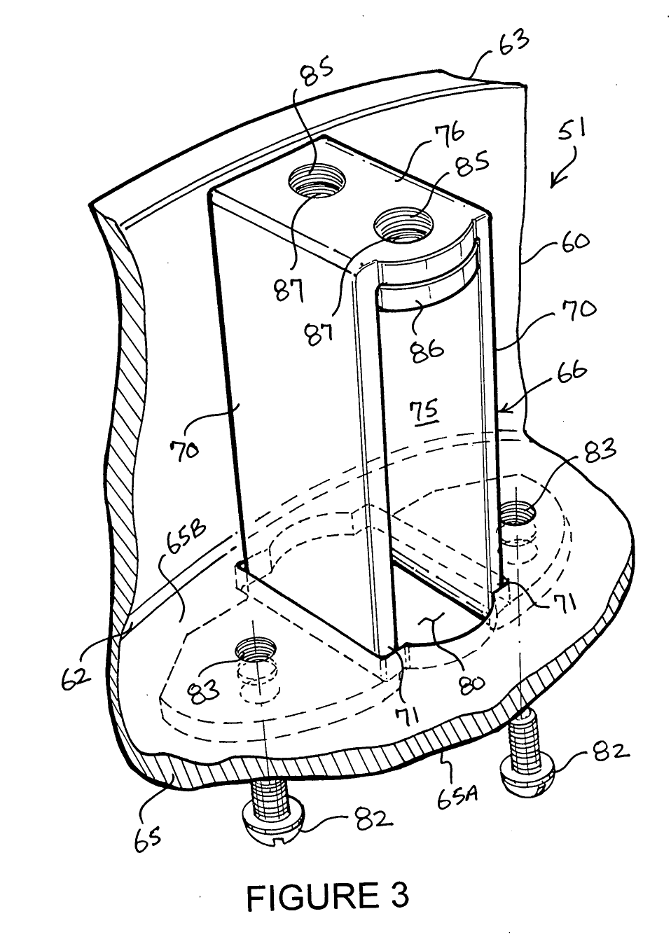

Opposed tower bracket openings 80 and 81 extend through top wall 65 on either side thereof, in accordance with the principle of the invention. The lower ends of tower brackets 66 and 67 are passed through tower bracket openings 80 and 81, in which the lower surfaces 73A of mounting tabs 73 of tower brackets 66 and 67 are brought to rest against outer surface 65A of top wall 65 on either side of openings 80 and 81, respectively. Mounting tabs 73 of tower bracket 66 provide two opposing load bearing points of engagement with top wall 65 on either side of opening 80, and mounting tabs 73 of tower bracket provide two opposing load bearing points of engagement with top wall 65 on either side of opening 81. With additional reference to FIG. 3 showing tower bracket 66, struts 70 are positioned in cavity 61 and project downwardly through cavity 61 from openings 80 and 81, from top end 62, and from inner surface 65B (not shown in FIG. 2) of top wall 65 to lower ends 72 and to attachment tab 76, which are positioned at bottom end 63 of sidewall 60.

Mounting tabs 73 are removably affixed to outer surface 65A of top wall 65 with screws 82, which pass through threaded openings 73C through tabs 73 and into correspondingly aligned threaded openings 83 through top wall 65 on either side of openings 80 and 81. Other suitable mechanical fastener forms may be used for removably securing mounting tabs 73 to top wall 65 without departing from the invention, such as nut-and-bolt assemblies. The mounted disposition of tower bracket 66 to box 51 is shown in FIG. 4, with the understanding that the mounted disposition of tower bracket 67 to box 51 is identical to that of tower bracket 66. As a matter of disclosure, FIG. 5 is a top plan view of junction box 51 with tower brackets 66 and 67 attached thereto and also illustrating mounting tabs 73 overlying outer surface 65A of top wall 65.

Attachment tabs 76 depend downwardly from top wall 65 and are used to attach and secure a load, such as a ceiling fan. As seen in FIG. 3 illustrating tower bracket 66, a pair of threaded openings 85 through attachment tab 76 provide threaded attachment points for use in securing a load, such as ceiling fan, with threaded bolts. In order to provide attachment tab 76 with increased structural rigidity and strength, attached to and overlying the underside of attachment tab 76 is a washer 86 having threaded openings 87 that are aligned with and correspond to threaded openings 85. Washer 86 is preferably welded to attachment tab 76, but it can be formed integrally with attachment tab 76 if desired or rigidly attached to attachment tab 76 in other ways, such as with rivets. Tower bracket 67 is also provided with such a washer. Although two threaded openings 85 are provided in conjunction with the attachment tabs 76 and washers 86 of tower brackets 66 and 67, less or more can be used.

Tower brackets 66 and 67 are exceptionally strong, stable, and resilient. The opposed, spaced-apart struts 70 of tower brackets 66 and 67 efficiently take up and disperse load born at the lower ends of tower brackets 66 and 67, and the two opposed load-bearing engagement points between tabs 73 of tower brackets 66 and 67, respectively, and top wall 65 disperse the load across top wall 65 allowing box 51 to sustain a surprisingly large amount of load. Furthermore, threaded openings 85 and 87 at the lower ends of tower brackets 66 and 67 provide threaded attachment points for threaded bolt for use in securing a load, in which the threaded ends of the bolts pass into and are accommodated by gaps 75 between struts 70 of the respective tower brackets 66 and 67, in accordance with the principle of the invention. In this way the load-bearing attachment points of tabs 73 to top wall 65 are positioned laterally outwardly of axis of load applied to the attachment tabs 76 of the respectively tower brackets 66 and 67.

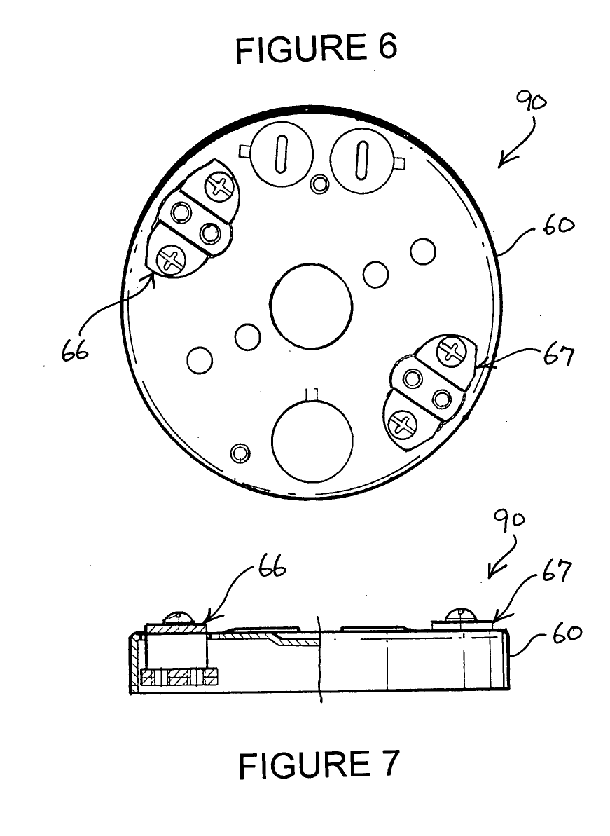

Reference is now made to FIGS. 6 and 7, which illustrate an alternate embodiment of a junction box 90 constructed and arranged in accordance with the principle of the invention. The embodiment depicted in FIGS. 6 and 7 is completely analogous to that just described except that box 90, rather than being of a standard size as is box 51, is in the form of a pancake-sized junction box. Box 90 utilizes a shorter sidewall 60 and shorter tower brackets 66 and 67. As before, box 90 can be mounted to the underside of a joist or other available mounting surface or be supported from an inter-joist hanger. Furthermore, boxes 51 and 90 each incorporate two tower brackets. However, less or more may be used depending on the required number of attachment points for a specified load.

Referring now to FIG. 8 an alternate embodiment of a tower bracket 100 is shown. In common with the previously described tower bracket embodiments designated at 66 and 67, tower bracket 100 shares struts 70, upper ends 71, lower ends 72, mounting tabs 73, gap 75, and attachment tab 76. Unlike the previously described tower brackets 66 and 67, a large, central, opening 100A is formed through attachment tab 76. An attachment clip 101, which is fashioned of the same material or combination of materials as tower bracket 100, is also provided, which has opposing, parallel clip extremities 102 and 103 joined at one end thereof by an end wall 104. Clip extremities 102 and 103 form a slot 105 therebetween. Attachment clip 101 is mounted onto attachment tab 76, in which attachment tab 76 is received into and through slot 75 positioning clip extremities 102 and 103 on either side of opening 100A. Opposing threaded openings 106 are formed through clip extremities 102 and 103, and are positioned on either side of opening 10A. Threaded openings 106 are completely analogous to a threaded opening of an attachment tab and a corresponding threaded opening of a washer of the tower brackets 66 and 67 as previously described, providing a threaded attachment point for supporting a load with a threaded bolt. Threaded openings 106 are, of course, aligned to receive a threaded bolt, and opening 100A through attachment tab 76 allows a threaded bolt to pass therethrough between threaded openings 106.

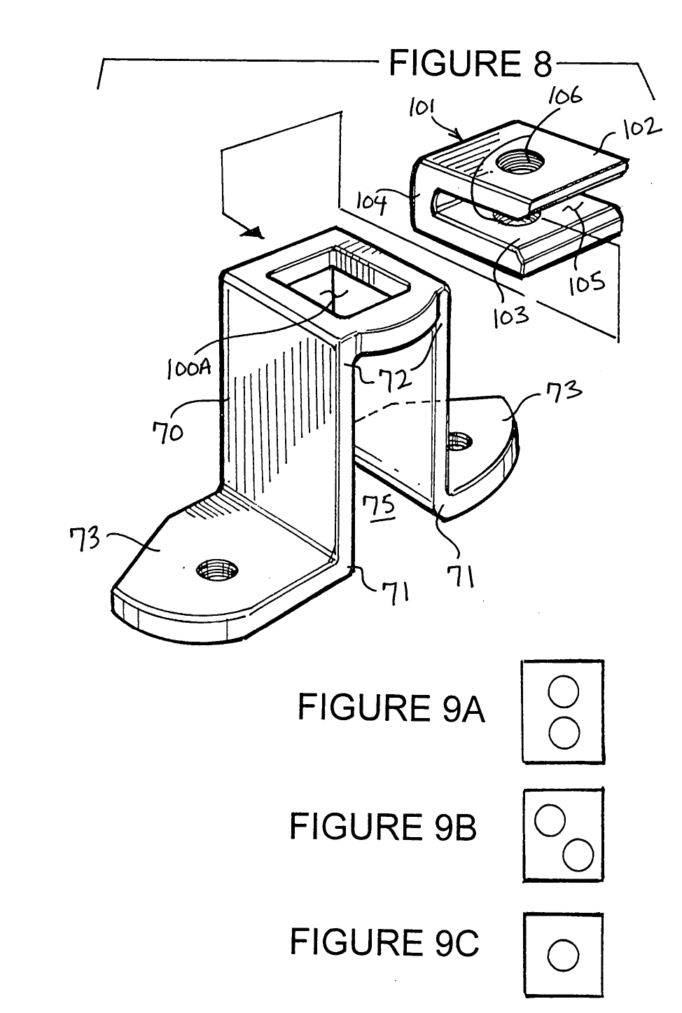

Although attachment clip 101 incorporates an aligned pair of threaded openings providing a single attachment point for a threaded bolt, it can incorporate more corresponding pairs of threaded openings and in various threaded hole patterns. To illustrate this point, FIGS. 9A-9C represent different threaded hole patterns for use in conjunction with the attachment clip of the tower bracket of FIG. 8, including a double hole pattern as shown in FIG. 9A for providing two threaded attachment points, an offset or angled double hole pattern as shown in FIG. 9B providing a different pattern of two threaded attachment points and, like the attachment clip embodiment depicted in FIG. 8, a single hole pattern providing a single threaded attachment point as shown in FIG. 9C. Other threaded hole patterns can be used depending on the desired number and/or pattern of the required attachment points. In this regard, it is to be understood that different attachment clips with different attachment point hole patterns can be provided and used as needed in conjunction with tower bracket 100, in accordance with the principle of the invention. The provision of an attachment clip with a tower bracket constructed and arranged in accordance with the principle of the invention constitutes an exemplary embodiment of the invention and allows a tower bracket to be used with a specified clip having a specified hole pattern, and allows for the replacement of attachment clips for suiting different or changing attachment specifications.

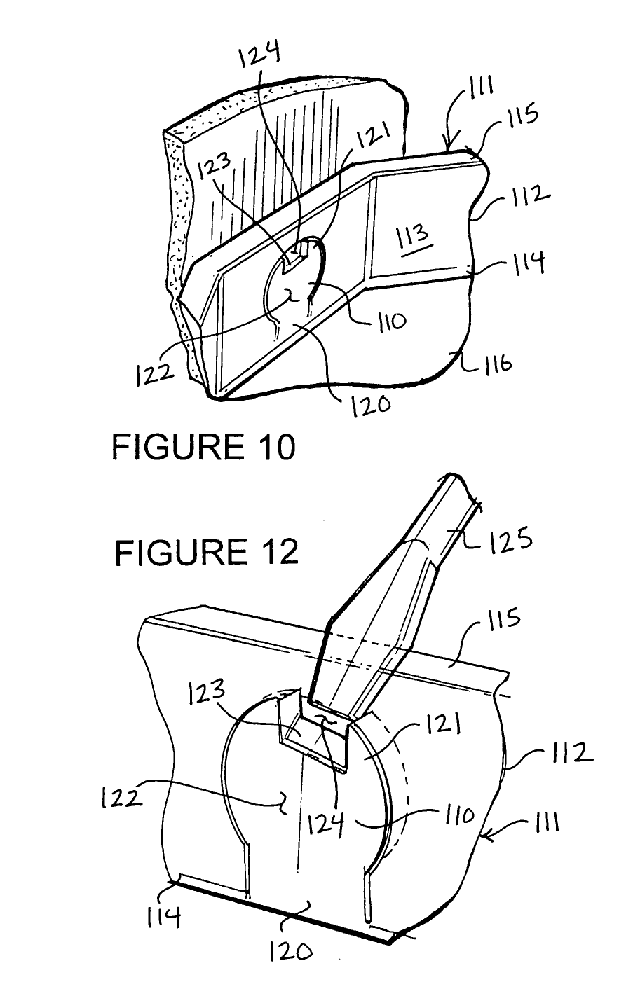

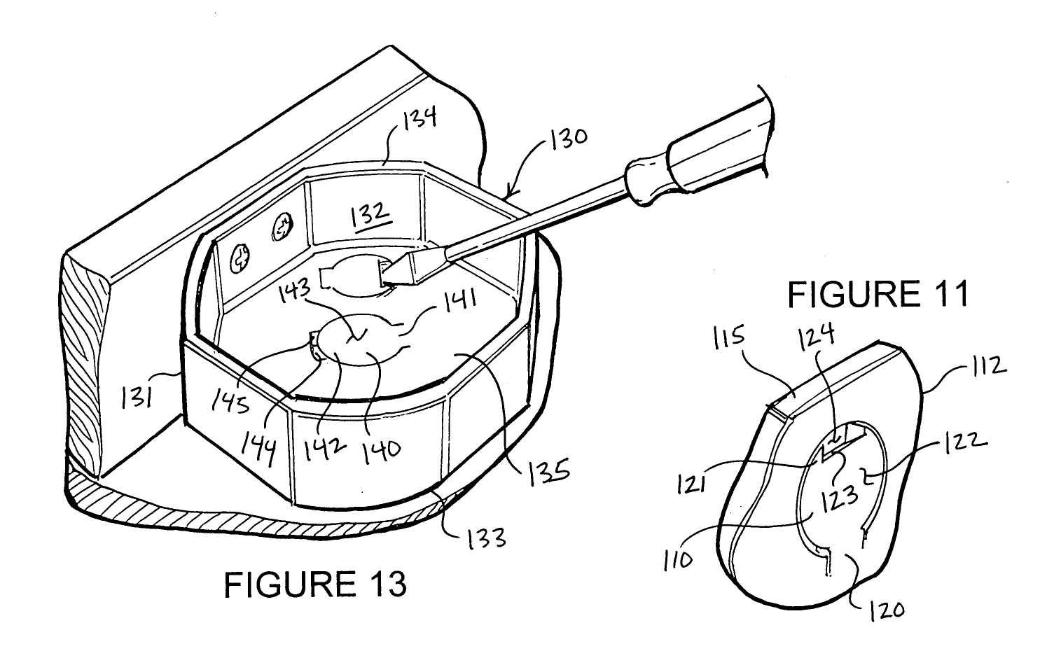

Conventional junction boxes incorporate one or more electrical knockout plugs, and the embodiment in FIG. 10 shows an exemplary embodiment of an improved knockout plug 110 incorporated with junction box 111 forming an embodiment of the invention. With the exception of knockout plug 110, junction box 111 is generally representative of a conventional junction box 111 including an annular sidewall 112 bounding an internally open cavity 113 extending between a top end 114 of sidewall 112 and a bottom end 115 of sidewall 112, and a top wall 116 overlying top end 114 of sidewall 112. In this embodiment, knockout plug 110 is incorporated with sidewall 112, has a proximal end 120 attached to sidewall 112 and an opposing distal end 121, and is disposed in a knockout opening 122 through sidewall 112. Looking also to FIGS. 11 and 12 showing enlarged views of a section of sidewall 112 including knockout plug 110, a notch 123 is formed into distal end 121 of knockout plug 110 forming a keyhole 124 that is able to accept an implement, such as a screwdriver 125 as shown in FIG. 12, for use in prying knockout plug 110 out of knockout opening 122 so that it may be then easily removed exposing knockout opening 122 to be used for passing electrical wires therethrough. Notch 123 is accessible by an implement for prying out knockout plug 110 from within cavity 113 and from outside box 111. As before, box 111 can be mounted to the underside of a joist or other mounting surface or be supported from an inter-joist hanger.

A junction box can incorporate any selected number of knockout plugs constructed and arranged in accordance with knockout plug 110, which is exemplary of a keyholed knockout plug. Also, although knockout plug 110 is located at sidewall 112 of box 111, it can be located elsewhere, including at top wall 116.

For the embodiment of FIG. 13, a junction box 130 is shown, which consists of an annular sidewall 131 bounding an internally open cavity 132 extending between a top end 133 of sidewall 131 and a bottom end 134 of sidewall 131, and a top wall 135 overlying top end 133 of sidewall 131. In this embodiment, knockout plug 110 is incorporated with top wall 135. Top wall 135 also incorporates a second knockout plug designated at 140, which has a proximal end 141 attached to top wall 135 and an opposing distal end 142, and is disposed in a knockout opening 143 through top wall 135. A notch 144 is formed into top wall 135 at distal end 142 forming a keyhole 145 that is able to accept an implement, such as a screwdriver or the like, for use in prying knockout plug 140 out of knockout opening 143 so that it may be then easily removed exposing knockout opening 143 to be used for passing electrical wires therethrough. Notch 144 is accessible by an implement for prying out knockout plug 140 from within cavity 132 and from outside box 130.

The instruction provided by knockout plug 140, which is exemplary of an alternate embodiment of a keyholed knockout plug, is the provision of notch 144 forming keyhole 145 not in knockout plug 144 as shown with the previous embodiment designated at 110 but in the structure of junction box 130 surrounding knockout plug 140, in accordance with the principle of the invention. Like the previous discussion, it is to be understood that a junction box can incorporate any number of knockout plugs 140 as may be desired and at any desired locations. As before, box 130 can be mounted to the underside of a joist or other mounting surface or supported from an inter-joist hanger. In FIG. 13, box 130 is shown as it would appear side mounted to joist 146.

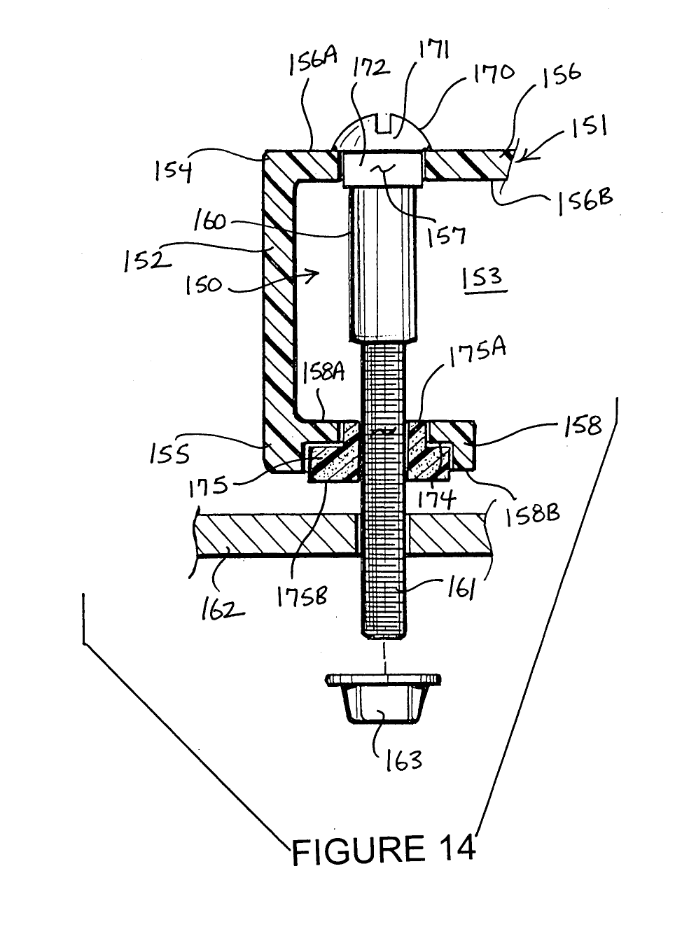

For the embodiment depicted in FIG. 14 there is illustrated a vertical sectional view of a mounting assembly 150 for use with a junction box 151 forming an exemplary embodiment of the invention. As before, junction box 151 consists of an annular sidewall 152 bounding an internally open cavity 153 extending between a top end 154 of sidewall 152 and a bottom end 155 of sidewall 152, and a top wall 156 overlying top end 154 of sidewall 152. Top wall 156 has an outer surface 156A and an opposing inner surfaced 156B directed into cavity 153. In this embodiment, a support bolt 160 depends from an opening 157 through top wall 156 of box 151 and into cavity 153 and to below bottom end 155 to a distal threaded end 161 onto which a load 162, such as a ceiling fan, is received and secured, such as with a threaded nut 163.

Bolt 160 has a proximal end 170 consisting of an enlarged head 171 positioned against outer surface 156A. Opening 157 is square in shape, and proximal end 170 has a square key 172 at opening 157 and that corresponds to the square shape of opening 157 thus inhibiting bolt 160 from rotating relative to opening 157, in accordance with the principle of the invention. Other shapes may be used between key 172 and opening 157 for inhibiting bolt 160 from rotating relative to opening 157, including corresponding rectangular shapes, oval shapes, triangular shapes, etc. Opening 161 is coaxial to an opposed opening 159 formed through a tab 158 formed laterally inward of bottom end 155 of sidewall 152. Threaded end 161 projects through opening 159, and tab 158 has an inner surface 158A facing inner surface 156B of top wall 156, and an opposing outer surface 158B into which is formed a recess 174. A bumper 175, which is constructed of an elastomeric or rubber-like material, encircles threaded end 161 and is situated in recess 174. Recess 174 is sized to accept and accommodate bumper 175. Bumper 175 has a narrowed upper end 175A extending into opening 159 that encircles threaded end 161 at opening 159, and an opposing enlarged lower end 175B projecting outboard of outer surface 158B and bottom end 155. Load 162 is forced against lower end 175B of bumper 175, which suppresses noise between load 162 and box 151 and also between threaded end 161 to tab 158, according to the principle of the invention.

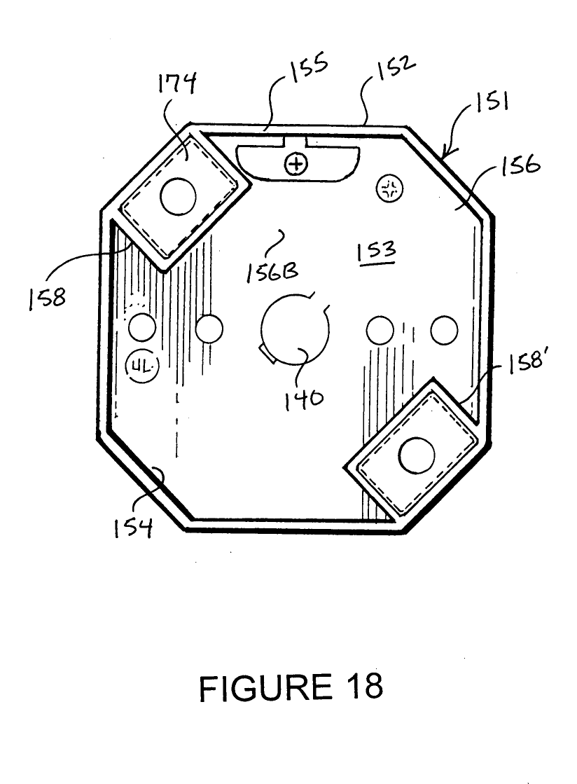

The mounting assembly 150 in FIG. 14 can be used in conjunction with a standard-sized junction box as shown, or with a pancake-sized junction box. Referring to FIGS. 17 and 18 in relevant part, junction box 151 is shown in its entirety including annular sidewall 152, cavity 153, top end 154 of sidewall 152, bottom end 155 of sidewall 152, top wall 156, tab 158 including recess 174 with bumper 175 shown spaced therefrom, and in addition to a corresponding tab 158′ oppositely displaced relative to tab 158, in which the structure and function of tab 158′ is identical to that of tab 158 and will not be discussed. Box 151 incorporates two tabs 158 and 158′ for accommodating two mounting assemblies 150, and it is to be understood that box 151 can be so configured for accommodate less or more as may be required for supporting a specified load. As before, box 151 can be mounted to the underside of a joist or other mounting surface or be supported from an inter-joist hanger. As a matter of example, top wall 156 incorporates knockout plug 140.

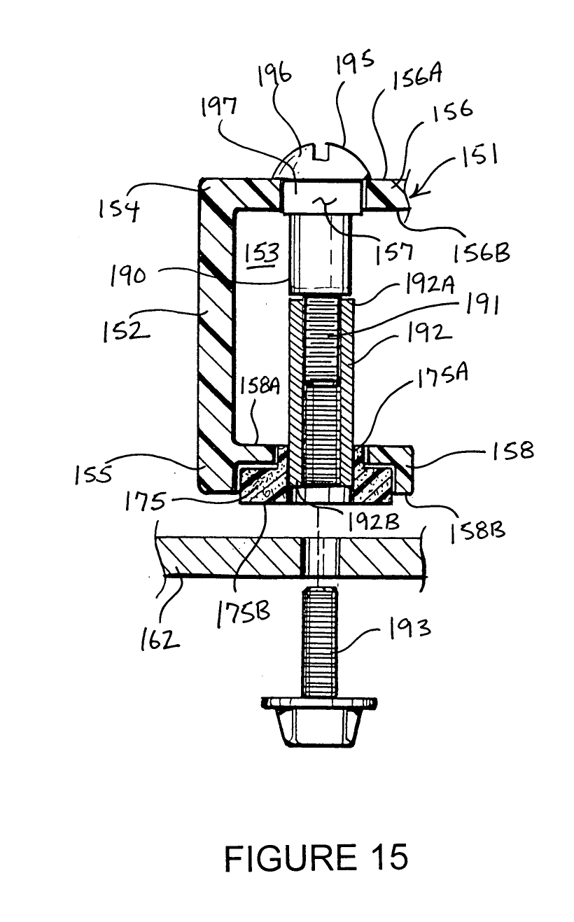

Referring now to FIG. 15, there is illustrated a vertical sectional view of a mounting assembly 189 for use with junction box 151 and which in FIG. 15 replaces mounting assembly 150 shown in FIG. 14 forming an exemplary embodiment of the invention. In this embodiment, a support bolt 190 depends from opening 157 through top wall 156 of box 151 into cavity 153 and to a distal threaded end 191 positioned between inner surface 156B of top wall 156 and upper surface 158A of tab 158, onto which is threadably received an upper end 192A of an internally threaded rivet 192. Rivet 192 extends downwardly through cavity 153 from its upper end 192 to its lower end 192B, which extends into and through opening 159 of tab 158 terminating a location in recess 174 between upper and lower surfaces 158A and 158B of tab 158, in accordance with the principle of the invention. Narrowed upper end 175A of bumper 175 extends into opening 159 and encircles lower end 192B of rivet 192, as also does an inboard portion of lower end 175B, in which lower end 192 of rivet 192 is located between upper end 175A and lower end 175B of bumper 175. Load 162, which, as before, is generally representative of a ceiling fan, is secured to lower end 192B of rivet 192 with a threaded nut 193, in which load 162 is captured against lower end 175B of bumper 175. As before, bumper 175 suppresses noise between load 162 and box 151 and also between lower end 192B of rivet 192 and tab 158, according to the principle of the invention.

Bolt 190 has a proximal end 195 consisting of an enlarged head 196 positioned against outer surface 156A. As before, opening 157 is square in shape, and proximal end 195 has a square key 197 at opening 157 and that corresponds to the square shape of opening 157 thus inhibiting bolt 190 from rotating relative to opening 157, in accordance with the principle of the invention. As before, other complementing shapes can be used for preventing rotation of bolt 190 relative to opening 157.

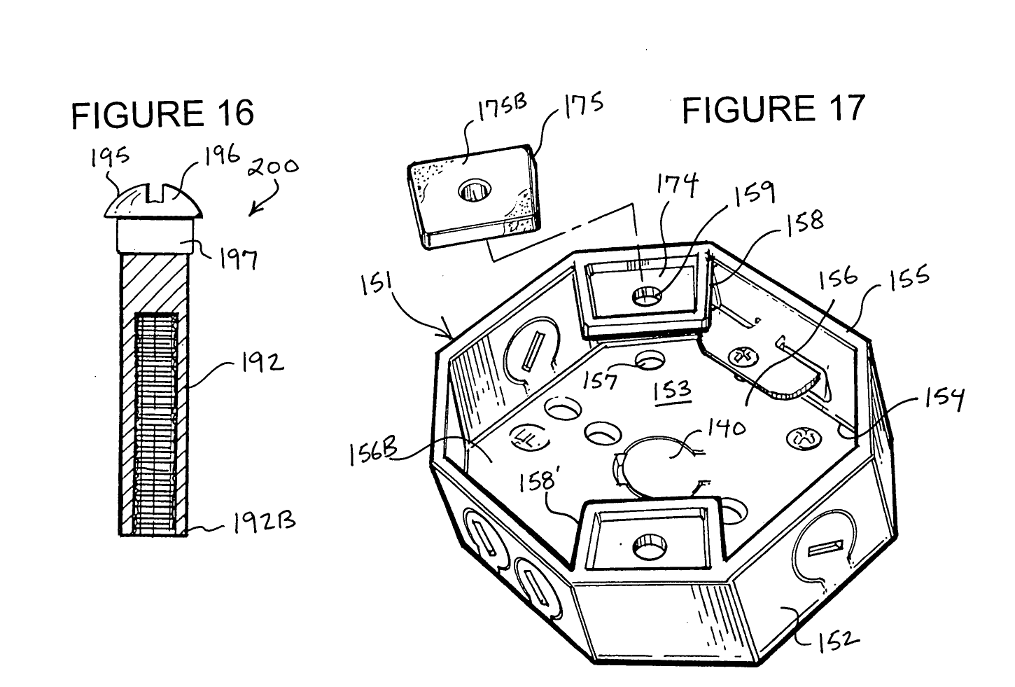

In FIG. 15, bolt 190 and rivet 192 are separate pieces. If desired, they can be provided as a combined integrally-formed shoulder rivet 200 as shown in FIG. 16, including an integral body consisting of proximal end 195 including head 196 and key 197 leading to internally threaded rivet 192 terminating downwardly with lower end 192A. Use of shoulder rivet 200 is identical to the use of the bolt 190 and rivet 192 combination in FIG. 15, with the exception that rivet 192 can be removed from bolt 190 as may be required for replacement or for replacing rivet 192 with a different rivet or a differently sized rivet in order to meet specific needs.

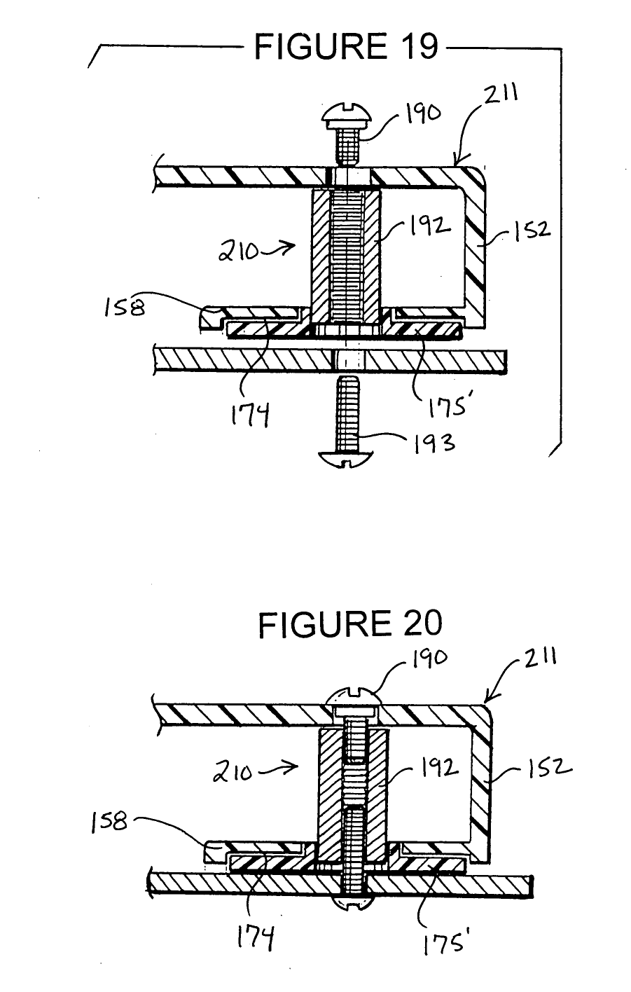

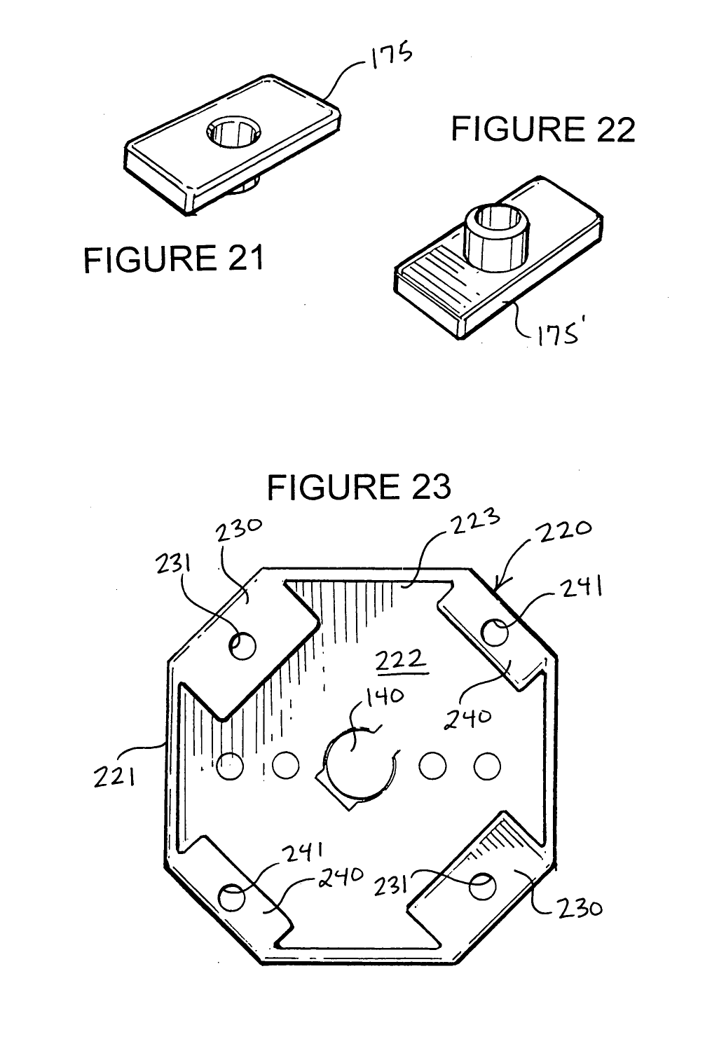

Reference is now made to FIGS. 19 and 20, which illustrate an alternate embodiment of a mounting assembly 210 in conjunction with a junction box 211 forming an exemplary embodiment of the invention. The embodiment depicted in FIGS. 19 and 20 is completely analogous to that just described in conjunction with FIG. 15, except that box 211, rather than being of a standard size as is box 151, is in the form of a pancake-sized junction box. Box 90 utilizes a short sidewall 152, a short and smaller bolt 190, a shorter and smaller rivet 192, a shorter and smaller bolt 193, and a wider and flatter and thinner bumper, which is denoted at 175′ and which is also depicted separately in FIGS. 21 and 22, which are different perspective views of bumper 175′. FIG. 19 shows mounting assembly 210 with bolt 190 and 193 detached, and FIG. 20 shows mounting assembly 210 with bolts 190 and 193 secured to either side of rivet 192. As before, box 211 can be mounted to the underside of a joist or be supported from an inter-joist hanger, and can incorporate any desired number of mounting assemblies 200.

For the embodiment of FIG. 23, bottom plan view of a junction box 220 is shown, which, as with the other junction boxes herein disclosed, consists of an annular sidewall 221 bounding an internally open cavity 222 extending between a top end 223 of sidewall 221 and a bottom end 224 of sidewall 221, and a top wall 225 overlying top end 223 of sidewall 221. In this embodiment, knockout plug 140 is incorporated with top wall 225. Oppositely displaced pairs of tabs 230 and 240 are formed laterally inward of bottom end 224 of sidewall 221. Openings 231 through tabs 230 and openings 141 through tabs 241 are coaxial to opposed openings (not shown) through top wall 225. Tabs 230 may each be used for taking one of the mounting assemblies herein previously described for supporting a load. It is to be noted that the lower surfaces of tabs 230 are not furnished with recesses for taking in bumpers, but that bumpers may still be used and simply positioned onto the lower surfaces of tabs 230. Tabs 230 are considerably larger than oppositely displaced tabs 240, which are provided and to be used for any conventional purpose. The purpose of illustrating the embodiment in FIG. 23 is to show the provision of pairs of oppositely displaced tabs 230 and 240, in which tabs 230 are considerably larger than tabs 240, in which tabs 230 are to be put to use for taking one of the mounting assemblies of the invention herein previously described, and in which tabs 240 are to be put to a different, conventional use, such as for sustaining a lesser load than that of the mounting assemblies associated with tabs 230.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A junction box, comprising:
an annularly configured sidewall bounding an internally open cavity extending between a top end of the sidewall and a bottom end of the sidewall;
a top wall overlying the top end of the sidewall; and
a tower bracket comprising opposing upstanding struts affixed to the top wall and projecting downwardly therefrom in the open cavity terminating with lower extremities affixed to an attachment tab positioned at the bottom end of the sidewall.

2. The junction box according to claim 1, further comprising a threaded opening through the attachment tab.

3. The junction box according to claim 1, further comprising a plurality of threaded openings through the attachment tab.

4. The junction box according to claim 1, further comprising:
the struts having upper ends; and
a mounting tab, carried by each of the upper ends of the struts, affixed to the top wall.

5. The junction box according to claim 1, further comprising:
an opening through the an attachment tab;
an attachment clip coupled to the attachment tab;
the attachment clip having opposing clip extremities positioned on either side of the opening; and
opposing threaded openings through the clip extremities, respectively.

6. The junction box according to claim 1, wherein the opposing upstanding struts are substantially parallel relative to each other.

7. The junction box according to claim 4, further comprising:
the top wall having an outer surface and an opposing inner surface directed toward the open cavity;
an opening through the top wall;
the upper ends of the struts extending through the opening through the top wall; and
the mounting tabs removably affixed to the outer surface of the top wall.

8. The junction box according to claim 7, further comprising a threaded screw removably affixing each of the mounting tabs to the outer surface of the top wall.

9. A junction box, comprising:
an annularly configured sidewall bounding an internally open cavity extending between a top end of the sidewall and a bottom end of the sidewall;
a top wall overlying the top end of the sidewall; and
a tower bracket comprising opposing, substantially parallel struts positioned in the open cavity and including upper extremities, each having a mounting tab removably affixed to the top wall, and opposing lower extremities affixed to an attachment tab positioned at the bottom end of the sidewall.

10. The junction box according to claim 9, further comprising a threaded opening through the attachment tab.

11. The junction box according to claim 9, further comprising a plurality of threaded openings through the attachment tab.

12. The junction box according to claim 9, further comprising:
an opening through the an attachment tab;
an attachment clip coupled to the attachment tab;
the attachment clip having opposing clip extremities positioned on either side of the opening; and
opposing threaded openings through the clip extremities, respectively.

13. The junction box according to claim 9, further comprising:
the top wall having an outer surface and an opposing inner surface directed toward the open cavity;
an opening through the top wall;
the upper extremities of the tower bracket extending through the opening through the top wall; and
the mounting tabs removably affixed to the outer surface of the top wall.

14. The junction box according to claim 9, further comprising a threaded screw removably affixing each of the mounting tabs to the top wall.

15. A junction box, comprising:
an annularly configured sidewall bounding an internally open cavity extending between a top end of the sidewall and a bottom end of the sidewall;
a top wall overlying the top end of the sidewall;
a tower bracket comprising opposing upstanding struts positioned in the open cavity and including upper extremities, each having a mounting tab, and opposing lower extremities affixed to an attachment tab positioned at the bottom end of the sidewall;
the top wall having an outer surface and an opposing inner surface directed toward the open cavity;
an opening through the top wall;
the upper extremities of the tower bracket extending through the opening through the top wall; and
the mounting tabs removably affixed to the outer surface of the top wall.

16. The junction box according to claim 15, further comprising a threaded opening through the attachment tab.

17. The junction box according to claim 15, further comprising a plurality of threaded openings through the attachment tab.

18. The junction box according to claim 15, further comprising:
an opening through the an attachment tab;
an attachment clip coupled to the attachment tab;
the attachment clip having opposing clip extremities positioned on either side of the opening; and
opposing threaded openings through the clip extremities, respectively.

19. The junction box according to claim 15, further comprising a threaded screw removably affixing each of the mounting tabs to the top wall.

20. The junction box according to claim 15, wherein the opposing upstanding struts are substantially parallel relative to each other.
